(19) United States
(12) Patent Application Publication
(10) Pub. No.: US 2021/0406844 A1
(43) Pub. Date: Dec. 30, 2021

(54) METHOD FOR CARRYING OUT MAINTENANCE WORK ON A COMPLEX STRUCTURAL COMPONENT

(71) Applicant: MTU Aero Engines AG, München (DE)

(72) Inventor: Michael Bartelt, Hannover (DE)

(73) Assignee: MTU Aero Engines AG, München (DE)

(21) Appl. No.: 17/266,042

(22) PCT Filed: Aug. 1, 2019
(86) PCT No.: PCT/DE2019/000208

§ 371 Date: Aug. 13, 2021

(30) Foreign Application Priority Data
Aug. 7, 2018 (DE) 10 2018 213 208.9

(51) Int. Cl. G06Q 10/00; G06F 9/455; F01D 25/28

(52) U.S. Cl. CPC G06Q 10/20; G06F 9/45558; F05D 2220/32; F05D 2230/72; F05D 2230/80; F01D 25/285

(57) ABSTRACT

The invention relates to a method for carrying out maintenance work on a complex structural component, in particular, a gas turbine, by means of a virtual work environment. The virtual work environment has a display device and a computing device, said computing device being connected to a memory device, in which the characteristics of the complex structural component, together with its component parts and their assembly sequence, are stored. During the method, at least one component part needing maintenance, or a predefined modification state of the structural component is selected in the virtual work environment From this step, the disassembly or assembly steps required for disassembling the component parts of the structural component are calculated and displayed, in order to obtain access to the at least one component part needing maintenance, or to achieve the selected modification state.

### BACKGROUND OF THE INVENTION

The invention relates to a method for carrying out maintenance work on a complex structural component, in particular a gas turbine, by a virtual work environment comprising a display device and a computing device, wherein the computing device is connected to a memory device, in which the characteristics of the complex structural component together with its component parts and their assembly sequence are stored.

A key factor in the implementation of maintenance work on complex structural components is a deep detailed knowledge of the construction of the structural component. In this case, an important role is played by the individual and generally specific detailed knowledge of workers in regard to efficiently planning and carrying out maintenance work. This detailed knowledge is crucially dependent on the technical and process-related experience of workers, personal inclinations, and the engagement of the individual person and, moreover, varies for different types of structural components as well. If maintenance work is to be carried out on different types of complex structural components, the consequence is often an increased susceptibility to errors and thus a prolonged maintenance time.

Various virtual work environments are known, particular from research, and are intended to assist the assembly or disassembly of complex structural components. Thus, Ahmad et al. (IFAC-PapersOnLine 48-3 (2015) 1726-1731) have presented generally important steps of a virtual engine assembly. In this case, the focus was virtual prototyping, which, particularly in the design and development process, affords great utility in preliminary checking of the relationships of an assembled structural component (collision analyses). Complex disassembly and assembly processes on existing structural components for maintenance purposes, and, in particular, a derivation and display of required assembly or disassembly steps required in order to obtain access to a component part of a complex structural component as well as a documentation of existing maintenance statuses with work performed and the degree of utilization of component parts of the structural component have hitherto been hardly regarded or implemented.

### SUMMARY OF THE INVENTION

Proceeding therefrom, the object of the present invention is to propose a method for carrying out maintenance work on a complex structural component by use of a virtual work environment, which assists planning and carrying out maintenance of the complex structural component and thus simplifies the maintenance, and, in particular, also reduces the maintenance time. This is achieved in accordance with the invention by the teaching herein. Advantageous embodiments of the invention are set forth in detail herein.

Proposed for achieving the object is a method for carrying out maintenance work on a complex structural component, in particular a gas turbine, by a virtual work environment. The virtual work environment has a display device and a computing device, wherein the computing device is connected to a memory device, in which the characteristics of the complex structural component together with its component parts and their assembly sequence are stored.

The method has the following steps:
(a) selection of at least one component part needing maintenance or of a predefined modification state of the structural component in the virtual work environment;
(b) calculation of the required disassembly or assembly steps together with their sequence for disassembling or assembling the component parts of the structural component in order to obtain access to the at least one component part needing maintenance or to achieve the selected modification state;
(c) display of the required assembly or disassembly steps in order to obtain access to the component part needing maintenance or to achieve the selected modification state.

The proposed method enables maintenance work to be carried out on complex structural components in a simplified manner in that, through the selection of the component part that is installed in the complex structural component and needs maintenance or through the selection of a predefined modification state of the structural component, the required disassembly or assembly steps together with their sequence are calculated and displayed to a maintenance mechanic in order to carry out the required work. By use of the proposed method, a reduction in the complexity of the process and in the susceptibility to errors is achieved, and a more rapid and more efficient exchange of information among the disciplines involved in the maintenance is made possible. Consequently, the proposed method makes it possible to increase the overall efficiency of performing the maintenance.

The proposed method serves for carrying out maintenance work on a complex structural component by use of a virtual work environment. The virtual work environment here has a display device for displaying the available and calculated information as well as a computing device that processes this information. The computing device is connected to a memory device, in which the characteristics of the complex structural component together with its component parts are stored, in particular also in connection with their assembly sequence.

A virtual model of the complex structural component exists in the memory device and has a volume model that can be displayed by the memory device for each relevant component part. The construction logic of the structural component and possible component part combinations is linked to the structural part complex formed therefrom and, for example, can also be linked to the parts list structure of the structural component. Further stored in the memory device are additional characteristics characterizing the component parts or component part groups (for simplicity, in the scope of the description of the invention, component part groups that, taken in their totality, represent a smaller functional unit of the complex structural component are also included under the term component part), characteristics such as, for example, dimensions, material, component part and serial numbers, version, or an inclusion in an assembly package.

A further property of component parts that is stored in the memory device is represented by the linking logic through which the assembly structure can be depicted. In this case, each component part together with its interfaces is assigned to other component parts of the complex structural component in an unequivocal manner. The assembly relationships are defined clearly by the linking logic. In the linking logic, for example, it is specified which component parts have to be disassembled first in order to disassemble another arbitrary component part.

The characteristics of component parts that are stored in the memory device can, in particular, also be modified when the proposed method is carried out for performing maintenance work. For example, by the virtual work environment, the proposed method makes possible a diagnosis of component parts, the result of which is stored directly in the memory device of the virtual work environment and is available for carrying out the further maintenance work. Thus, it is possible to store information about the state of a component part, such as, for example, the positions and kinds of existing damage, which, for example, can be marked directly on the virtual component part and the extent of which can be specified. As needed, photos or measurement results in regard to the damage can also be stored in the memory device.

In a first step a), at least one component part needing maintenance or a predefined modification state of the structural component is selected in the virtual work environment. This step can be carried out, for example, by a maintenance planner, who plans the maintenance beforehand, or else directly by a maintenance mechanic who is already engaged in the maintenance of the structural component and, for example, prepares at least one further maintenance step arising from the maintenance work. In the same way, however, it is also possible for other workers engaged in the maintenance work that is to be carried out to select a component part that is to undergo maintenance or to select a predefined modification state of the structural component in order to obtain desired information and assistance. A modification state is a defined structural state of the complex structural component, for which it is exactly defined which component parts of the structural component are assembled in this modification state on the structural component and which component parts are disassembled.

In a second step b), the required disassembly or assembly steps together with their sequence for disassembling or assembling component parts of the structural component are calculated in order to obtain access to the at least one component part needing maintenance or in order to achieve the selected modification state. For this step, which comprises not only classical calculations, but also other kinds of data acquisition, the computing device resorts to the data stored in the memory device, such as, in particular, the linking logic of the component parts. The optimal sequence of disassembly or assembly steps is also calculated. In connection with the internal linking logic, it is determined which other component parts must be minimally uninstalled as well in order to disassemble a desired component part. On the basis of this data situation, it is possible to calculate a tailored work sequence, in which, for example, simulation sequences of disassembly instructions can then also be integrated.

In the calculation of the required disassembly or assembly steps together with their sequence for disassembling or assembling component parts, it is even possible in preliminary preparation for carrying out maintenance to test different dismantling variants, to identify the component parts in question, and to reveal potential conflicts between exchanged parts. Thus, it is possible early on to estimate any risks associated with the maintenance task, to determine the effort required for disassembly or assembly, and thus to determine the throughput time as well as the expected costs of the maintenance.

In a third step c), the previously calculated assembly or disassembly steps that are required in order to obtain access to a component part needing maintenance or in order to achieve the selected modification state are displayed. A suitable display of all available information and calculated data that most optimally assists a worker who is applying the method in the worker's activity is to be selected here. Thus, for example, it is also possible to display graphically the resulting dismantling effort by way of, for example, an exploded drawing of all involved component parts in order to obtain an overview of the intended maintenance action and, under certain circumstances, to undertake a modification of the calculated assembly or disassembly steps.

In a further development of the method, in a further step d), disassembly or assembly steps carried out on the structural component are documented in the memory device. Thus, it is possible to store performed work steps, for example, directly in the virtual work environment. This can be done, for example, directly by a maintenance mechanic by an electronic confirmation, as a result of which it is also possible to reduce the effort involved in the documentation and archiving of performed maintenance work.

For example, the complex structural component could be depicted on a display device while the maintenance work is being carried out, with the component that is to undergo maintenance being highlighted in color in the overview depiction. The work steps that are to be carried out can then be followed step by step, if necessary, in a drawing, a 3D model, or an animation, for example, and then stored for later retrieval, for example. If the corresponding component part has been disassembled or assembled as intended, it is possible to confirm this by way of an input device. For example, the component part that has undergone maintenance could then be depicted in another color in the overview depiction. In this way, it is possible during the maintenance to undertake a continual, process-accompanying inspection of the performed disassembly or assembly work and thus to reduce further the susceptibility to errors and to increase productivity.

In a further development of the method, in step b), the availability of the at least one component part needing maintenance is checked and is displayed in step c). Accordingly, it is possible to reconcile component parts needing replacement, if need be, against stock inventories even before the maintenance work on the structural component has begun. An early check is thereby possible as to whether, if necessary, sufficient replacement parts are available. This increases the planning reliability and reduces delays in the time course of maintenance actions. In a similar way, this is also possible for reconciliation against used-part databases, so that, already in the preliminary planning, it is possible to identify component parts of critical material importance. In the virtual work environment, this information can be highlighted, in particular, by a colored marking of the parts in question.

In a further development of the method, the characteristics of the component part of the assembly group that are stored in the memory device have the respective current maintenance state of the component part. In this further development of the method, there exists a respective current report of the state of the structural component. In conjunction with the documentation of current disassembly and assembly steps and a linking of component part characteristics associated therewith, it is thus possible to prepare a progress report. An improved, targeted work planning is thereby possible. The disassembly or assembly progress of the structural component can also be visualized here, for example, by a colored marking of the component part.

In a further development of the method, the accessibility of each component part of the structural component is assigned to a predefined modification state. As already stated, a modification state is a defined structural state of the complex structural component, for which it is exactly defined which component parts of the structural component are assembled in this modification state on the structural component and which component parts are disassembled. The assignment of component parts to a predefined modification state facilitates the definition of the current assembly situation, in particular in the case of increasing complexity of a complex structural component, so that, through a predefinition of modification states, it is possible to reduce the complexity of the description and the carrying out of maintenance tasks.

In a further development of the method, in the calculation in step b), predefined assembly packages are also included, in which predefined disassembly or assembly steps together with their sequence for assembling or disassembling component parts of the structural component are defined. Defined in such a predefined assembly package are the disassembly or assembly steps, together with their sequence, that are required in order to bring the structural component from a first modification state into a second modification state.

In a further development of the method, a structural component has a predefined state after at least one predefined assembly package has been executed. The proposed approach also makes it possible, by use of the virtual work environment, to achieve a desired modification state of the structural component. In this case, starting from a first modification state, the required assembly packages by which the desired second modification state can be achieved are determined. One assembly package or a plurality of successively carried out assembly packages usually represents or represent here the most economical course of disassembly or assembly that is required in order to arrive at a predefined modification state.

In a further development of the method, in step b), there is made a flaw analysis and/or a damage analysis of the structural component. In this embodiment, such a flaw analysis and/or damage analysis are or is possible in the virtual work environment directly on the structural component depicted on a display device, whereby, regardless of the region of the structural component that is analyzed, it is also possible to depict specific modification states or individual structural groups of the model or, for example, also to depict sectional representations. In this way, it is possible to identify and understand more easily technical relationships that, without the proposed method, would be identifiable possibly only upon full dismantling of the structural component. Thus, it is possible, even prior to disassembly of the structural component, to identify the causes of potential flaws and to plan targeted inspection and dismantling.

In a further development of the method, in step b), a work plan is prepared and is output in step c). By use of such work plans, it is possible to specify to a mechanic in a tailored and step-by-step manner the disassembly or assembly of the region of the engine in question. Digitally prepared documents that are produced thereby can be shown, for example, both on display screens, in particular during production, and on mobile devices. In this case, the work plans can be furnished with interactive control elements and graphic elements, such as animations of the disassembly and assembly steps, exploded and detailed drawings, or short videos that explain especially complex work steps. Such work plans can also be prepared, for example, in accordance with a building block principle.

In a further development of the method, the display device is a display, a set of virtual-reality glasses, or a head-up display. Such display devices also enable the worker to show assisting information in regard to the work step as so-called augmented reality information directly in the projection area of the display device. Furthermore, it is also possible to integrate into the individual work steps simulation sequences of the disassembly or assembly instructions, for example, which are shown to the mechanic on a display device that is suitable for this purpose.

In a further aspect of the invention, a virtual work environment for carrying out maintenance work on a complex structural component, in particular on a gas turbine, is proposed. The virtual work environment has a display device and a computing device, with the computing device being connected to a memory device, in which the component parts of the complex structural component together with their assembly sequence and their characteristics are stored. In accordance with the invention, the virtual work environment is set up to implement the above-described method for carrying out maintenance work on a complex structural component, with at least one of the features of the method in the preceding description being realized.

### BRIEF DESCRIPTION OF THE DRAWING FIGURES

Further features, advantages, and possible applications of the invention ensue from the following description in conjunction with the figures. Herein:

FIG. 1 shows a schematic illustration of an exemplary embodiment of a virtual work environment according to the invention, which is suitable for carrying out a method according to the invention; and

FIG. 2 shows a schematic illustration of the course of the method according to the invention.

### DESCRIPTION OF THE INVENTION

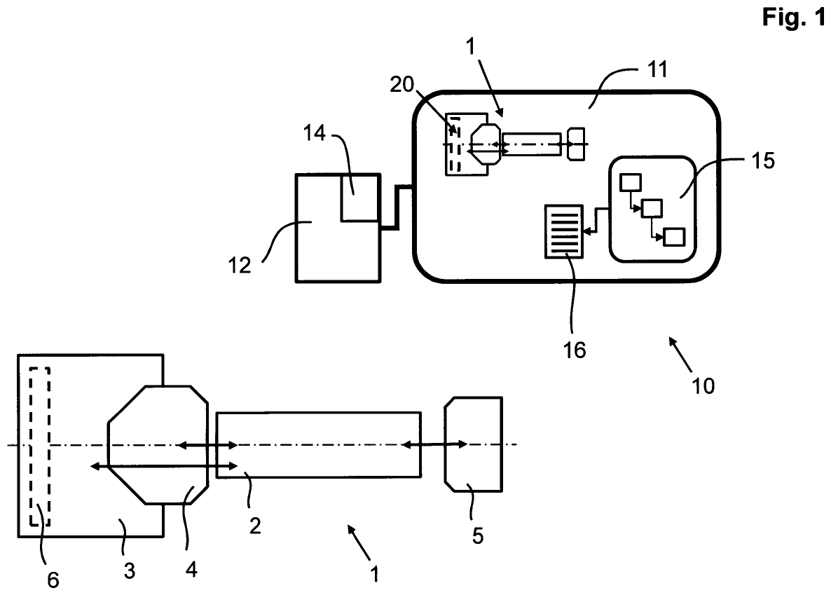

FIG. 1 shows a schematic illustration of an exemplary embodiment of a virtual work environment according to the invention for a complex structural component 1, which, in the exemplary embodiment, embodies a gas turbine 1 and on which maintenance work is carried out. Illustrated symbolically in FIG. 1 by arrows is the assembly and disassembly of structural groups, as a result of which the gas turbine 1 is brought into different modification states. Thus, during maintenance work, different structural groups, such as the fan 6 with the housing 3, the compressor 4, or the turbine 5 of the core module 2 of the gas turbine 1, are disassembled and subsequently re-assembled.

While the gas turbine 1 undergoing maintenance is depicted at the bottom left in

FIG. 1, the virtual work environment 10 employed in this case is depicted at the top right in FIG. 1. The virtual work environment 10 has a display device 11, on which a virtual illustration of the gas turbine 1 is displayed. The virtual work environment 10 further has a computing device 12, which is connected to a memory device 14. The characteristics of the gas turbine 1 together with its component parts and their assembly sequence are stored in the memory device 14.

When the method according to the invention is carried out in the virtual work environment 11, a component part that is to undergo maintenance or a predefined modification state of the gas turbine 1 is selected. In the exemplary embodiment, such a predefined modification state 20 is a state in which the fan 6 together with the housing 3 of the core module 2 of the gas turbine 1 is disassembled.

Once a predefined modification state 20 has been selected, the computing device 12 performs a calculation of the disassembly or assembly steps required by the current state, together with their sequence for disassembling or assembling component parts of the gas turbine 1, that need to be carried out the in order to achieve the selected modification state 20. The computing device 12 resorts here to information regarding component parts and modification states 20 that is stored in the memory device 14. After the calculation thereof, the required assembly or disassembly steps for achieving the selected modification state 20 are displayed on the display device 11. Insofar as it is desired and provided for in the method carried out in the scope of the calculation of the required disassembly or assembly steps together with their sequence for disassembling or assembling component parts of the gas turbine 1, a work plan 16 is prepared, which, in the illustrated exemplary embodiment, is likewise displayed on the display device 11.

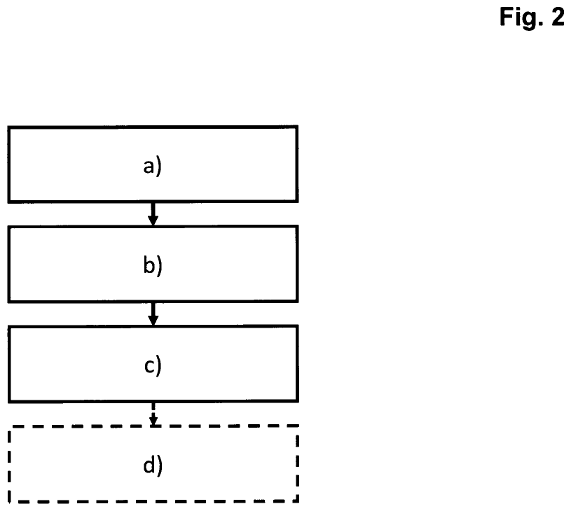

FIG. 2 shows a schematic illustration of the course of the method according to the invention for carrying out maintenance work on a complex structural component 1 by a virtual work environment 10, which has a display device 11 and a computing device 12. The computing device 12 is connected to a memory device 14, in which the characteristics of the complex structural component 1 together with its component parts, such as those of the fan 6, are stored together with the assembly sequence thereof. The method according to the invention has the following steps:

In a first step a), at least one component part needing maintenance, such as the fan 6, or a predefined modification state 20 of the structural component 1 is selected in the virtual work environment 10. Subsequently, in a second step b), the required disassembly or assembly steps together with their sequence for disassembling or assembling component parts of the structural component 1 are calculated in order to obtain access to the at least one component part needing maintenance (for example, the fan 6) or in order to achieve the selected modification state 20. In a further step c), the previously calculated assembly or disassembly steps that are required in order to obtain access to the component part needing maintenance 6 or in order to achieve the selected modification state 20 are displayed. In an optional further step d), disassembly or assembly steps carried out on the structural component 1 are documented in the memory device 14.

1. A method for carrying out maintenance work on a complex structural component,
by a virtual work environment which has a display device and a computing device, wherein the computing device is connected to a memory device, in which the characteristics of the complex structural component together with its component parts and their assembly sequence are stored, comprising the following steps:
a) selecting at least one component part needing maintenance or of a predefined modification state of the structural component in the virtual work environment;
b) calculating the required disassembly or assembly steps together with their sequence for disassembling or assembling component parts of the structural component in order to obtain access to the at least one component part needing maintenance or in order to achieve the selected modification state;
c) displaying the required assembly or disassembly steps in order to obtain access to the component part needing maintenance or in order to achieve the selected modification state.

2. The method for carrying out maintenance work according to claim 1, further comprising the step of:
d) documenting in the memory device disassembly or assembly steps carried out on the structural component.

3. The method for carrying out maintenance work according to claim 1, wherein, in step b), the availability of the at least one component part needing maintenance is also checked and is displayed in step c).

4. The method for carrying out maintenance work according to claim 1, wherein the characteristics of the component parts of the assembly group stored in the memory device have the current maintenance state of the component part.

5. The method for carrying out maintenance work according to claim 1, wherein the accessibility of each component part of the structural component is assigned to a predefined modification state.

6. The method for carrying out maintenance work according to claim 1, wherein, in the calculation in step b), predefined assembly packages are also included, in which predefined disassembly and assembly steps together with their sequence for assembling or disassembling component parts of the structural component are defined.

7. The method for carrying out maintenance work according to claim 1, wherein, after execution of at least one predefined assembly package, the structural component has a predefined modification state.

8. The method for carrying out maintenance work according to claim 1, wherein, in step b), a flaw analysis and/or a damage analysis of the structural component is made.

9. The method for carrying out maintenance work according to claim 1, wherein, in step b), a work plan is prepared and is output in step c).

10. The method for carrying out maintenance work according to claim 1, wherein the display device is a display, a set of virtual-reality glasses, or a head-up display.

11. A virtual work environment for carrying out maintenance work on a complex structural component, having a display device and a computing device, wherein the computing device is connected to a memory device, in which the component parts of the complex structural component together with their assembly sequence and their characteristics are stored, wherein it is configured and arranged to carry out the method according to claim 1.

12. The method of claim 1, wherein the complex structural component is a gas turbine.

13. The virtual work environment of claim 11, wherein the complex structural component is a gas turbine.
